(19) United States
(12) Patent Application Publication
(10) Pub. No.: US 2010/0125593 A1
(43) Pub. Date: May 20, 2010

(54) Method and system matching regular expressions in electronic message traffic

(76) Inventors: Nayan Amrvtlal Suthar, Pune (IN); Harshad Agashe, Pune (IN); Ajit Shelat, Pune (IN)

Correspondence Address: PATRICK REILLY, P.O. BOX 7218, SANTA CRUZ, CA, 95061-7218, US

(21) Appl. No.: 12/313,220

(22) Filed: Nov. 17, 2008

(51) Int. Cl. G06F 17/30

(52) U.S. Cl. 707/758; 707/E17.107; 709/206

(57) ABSTRACT

A system and method to perform regular expression pattern matching is provided. A data stream is fed into a plurality of character match units, or CMU's, that are organized in series. A same character of the datastream is written into each of the CMU's for matching. A failure or success of the match attempt with a stored character of a selected CMU is reported to a pattern sequencing logic. A succeeding character of the datastream is then written into each of the CMU's for another character match attempt. The plurality of CMU's and the pattern sequencing logic may be comprised with a single pattern match unit, or PMU. The PMU may be controlled by a configuration data that is loaded into the PMU. The configuration data may consist of: (a.) pattern characters and length information; (b.) repetition and anchoring control; (c.) local character class definitions; and (d.) pattern sequencing information.

### BACKGROUND OF THE INVENTION

1. Field of the Invention

The present invention relates generally to processing electronic messages in an electronics communications network. More particularly, the present invention relates to examining digitized electronic message traffic to determine the inclusion of message content that matches a regular expression pattern. It is understood that the term “message content” as defined herein includes any information or pattern contained within electronic message traffic, to include message headers, source or destination addresses, and formatting information.

2. Description of the Background Art

Regular expression pattern matching is used in the prior art to determine whether information contained within electronic message content matches a prespecified pattern. Regular expression matching may be used to determine whether an electronic message includes information or other digitized pattern that indicates a possibility that the comprising message is part of an attempt at unauthorized intrusion of or unauthorized communication with a computational system or network.

A regular expression is a set of symbols or characters and may include syntactic elements and/or one or more metacharacters. A useful regular expression may be used to search for patterns of digitized information or values described by the regular expression and possibly contained within an electronic document or documents, to include electronic message traffic.

Prior art implementations of regular pattern matching techniques, including deterministic and non-deterministic finite state machines, often require the implementation of electronic memory resources. Most such applications of electronic memory circuitry increase system cost and impose time delays in the application of regular expression pattern matching. The performance of these prior art solutions that use electronic memory resources is particularly limited by the input/output bandwidth and latencies of the memory circuitry. Additionally, non-deterministic finite state machine based solutions do not provide deterministic performance.

Certain other prior art approaches use programmable logic devices, such as field programmable logic arrays. This type of system design requires compiling regular expressions directly into regular expression specific logic that is loaded on to the programmable logic devices and often requires reprogramming of devices when new regular expressions are to be applied.

The prior art fails to optimally enable reliable matching of regular expressions contained within electronic message traffic. There is therefore a long felt need, and it is an object of the method of the present invention, to provide a method and system to perform matching of regular expressions with digitized information contained within electronic message traffic or other electronic documents.

This invention has two major functional advantages over other approaches: (a) deterministic performance and (b) minimum memory requirement. Designs that have “per-pattern” logic require that the logic is configurable with different patterns at different times. The amount of configuration data per pattern should be minimized to enable higher performances and scalability. This invention achieves this very effectively.

### SUMMARY OF THE INVENTION

Towards this object and other objects that will be made obvious in light of this disclosure, a first alternate preferred embodiment of the method of the present invention provides a system and method to perform regular expression pattern matching. In the first alternate preferred embodiment of the method of the present invention, or first method, a plurality of character match units, or CMU's, are organized in series. A data stream is fed into the plurality of CMU's whereby a same character of the data stream is written into each of the CMU's. An individual CMU is then enabled to perform a match against a character of a stored signature and report a failure or success of the match attempt to a character sequencing logic. The character sequencing logic then enables a set of CMUs depending on the failure or success of the match attempt. A succeeding character of the datastream is then written into each of the CMU's for the performance of another character match attempt. The plurality of CMU's and the character sequencing logic may be comprised within a single pattern match unit, or PMU.

The behavior of the PMU may be controlled by a configuration data, or signature, that is loaded into the PMU. The configuration data may consist of: (a.) pattern characters and length information; (b.) repetition and anchoring control; (c.) character class definitions; and (d.) pattern sequencing information.

A character class is defined is defined herein as a set of one or more software encoded characters or meta-characters. A local character class is defined herein as a set of one or more characters for matching purposes specific to a PMU. A global character class is defined herein as a set of one or more characters for matching purposes used generally in all PMUs. Representations of characters of any class can are hard wired into electronic circuitry, e.g., by writing into random access memory, a microprocessor register, firmware, electronic logic gates, programmable logic units, and reprogrammable logic devices.

A plurality of signatures may be stored in a system memory and the plurality of signatures required by a particular data stream may be loaded into the array of PMUs as required.

Multiple such PMU arrays can be formed. Each PMU array can be fed with different data streams simultaneously to achieve higher performance. The same data stream can be fed into multiple PMU arrays to achieve scaling in terms of number of patterns.

The data stream may be in certain alternate preferred embodiments of the Method of the Present Invention moved at the rate of one byte every clock, irrespective of complexity of the patterns and also the number of patterns to be matched. The instantiation of these embodiments may result into deterministic performance of a system.

A first alternate preferred embodiment of the Present Invention comprises a network computer coupled with an information technology network. The network computer may include an interface to receive a data stream from the information technology network; a memory device or circuit storing a plurality of signatures; a plurality of pattern matching units (“PMU's”) coupled with memory device or circuit and configured to receive a data stream, and a pattern sequencing logic coupled to each PMU. The character sequencing may be configured to selectively enable CMU's after a match is detected by each CMU previous in series to the enabled CMU. One or more of the PMU's may include an input stream decoder configured to receive a data stream; and a plurality of character matching units (“CMU's”) organized into a series and configured to accept data from the input stream decoder.

The foregoing and other objects, features and advantages will be apparent from the following description of the preferred embodiment of the invention as illustrated in the accompanying drawings.

### INCORPORATION BY REFERENCE

U.S. Pat. No. 7,308,715 entitled “Protocol-parsing state machine and method of using same”; U.S. Pat. No. 7,225,466 entitled “Systems and methods for message threat management; U.S. Pat. No. 6,792,546 entitled “Intrusion detection signature analysis using regular expressions and logical operators”; U.S. Pat. No. 6,609,205 entitled “Network intrusion detection signature analysis using decision graphs”; and U.S. Pat. No. 6,487,666 entitled “Intrusion detection signature analysis using regular expressions and logical operators” and United States Patent Application Publication Serial No. 20080140662 entitled “Signature Search Architecture for Programmable Intelligent Search Memory”; United States Patent Application Publication Serial No. 20080140600 entitled “Compiler for Programmable Intelligent Search Memory”; United States Patent Application Publication Serial No. 20080047012 entitled “Network intrusion detector with combined protocol analyses, normalization and matching”; United States Patent Application Publication Serial No. 20070300301 entitled “Instrusion Detection Method and System, Related Network and Computer Program Product Therefor”; United States Patent Application Publication Serial No. 20070195814 entitled “Integrated Circuit Apparatus And Method for High Throughput Signature Based Network Applications”; United States Patent Application Publication Serial No. 20060191008 entitled “Apparatus and method for accelerating intrusion detection and prevention systems using pre-filtering”; United States Patent Application Publication Serial No. 20060174341 entitled “Systems and methods for message threat management”; United States Patent Application Publication Serial No. 20060107321 entitled “Mitigating network attacks using automatic signature generation”; United States Patent Application Publication Serial No. 20050238010 entitled “Programmable packet parsing processor”; United States Patent Application Publication Serial No. 20050203921 entitled “System for protecting database applications from unauthorized activity”; and United States Patent Application Publication Serial No. 20050114700 entitled “Integrated circuit apparatus and method for high throughput signature based network applications” are incorporated herein by reference and for all purposes. In addition, each and all publications, patents, and patent applications mentioned in this specification are herein incorporated by reference to the same extent in their entirety and for all purposes as if each individual publication, patent, or patent application was specifically and individually indicated to be incorporated by reference.

### BRIEF DESCRIPTION OF THE DRAWINGS

These, and further features of the invention, may be better understood with reference to the accompanying specification and drawings depicting the preferred embodiment, in which:

FIG. 1, FIG. 1 is a schematic diagram of a first preferred embodiment of the Present Invention, or first version;

FIG. 2. FIG. 2 is a schematic of the input stream decoder of the first version of FIG. 1;

FIG. 3 is an illustration showing a fixed range detector of an input stream decoder of FIGS. 2 and 3;

FIG. 4 is an illustration of a programmable range detector the input stream decoder of FIG. 2;

FIG. 5 is an illustration of a character range detector of the first version of FIG. 1;

FIG. 6 is an illustration of a single character detector of the first version of FIG. 1;

FIG. 7 is an illustration of a contiguous range detector of the first version of FIG. 1;

FIG. 8 is a schematic diagram of a pattern match unit of the first version of FIG. 1;

FIG. 9 is an optional case normalizer circuit of the input stream decoder of FIG. 1;

FIG. 10 illustrates an optional global enable circuit of a pattern match unit of FIGS. 1 and 8;

FIG. 11 is a schematic of a character match unit of FIGS. 1 and 8; and

FIG. 12 is an illustration of a character match unit enable logic of one or more a character match units of FIG. 1, 8 or 11.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

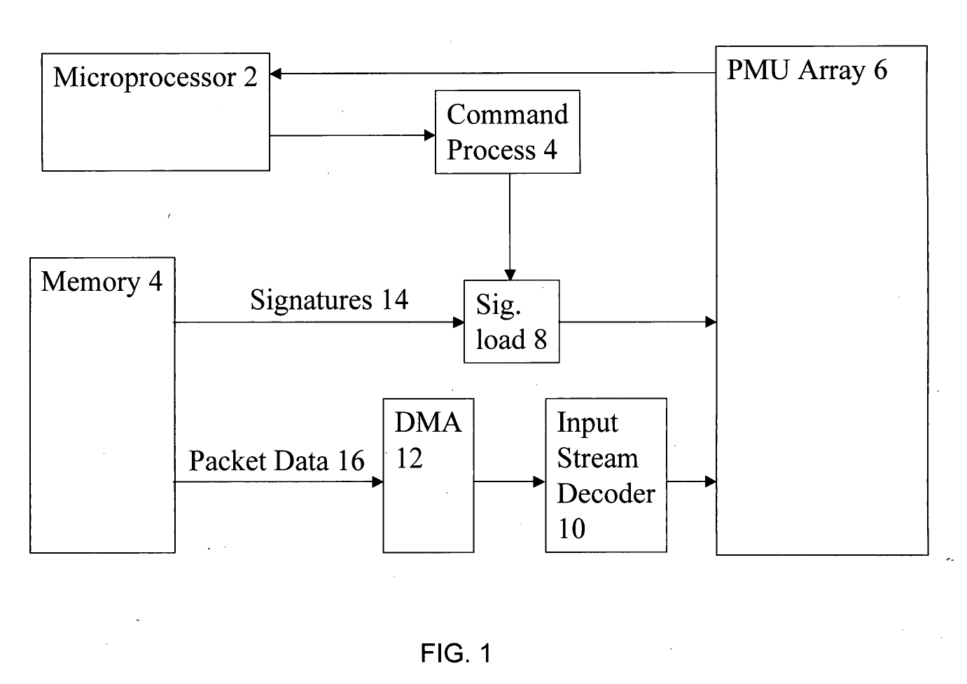

Referring now generally to the Figures and particularly to FIG. 1, FIG. 1 is a schematic diagram of a first preferred embodiment of the Present Invention, or “first version”. The first version comprises and uses a plurality of pattern match units PMU Array 6 to simultaneously match against incoming character stream at line rates. The microprocessor 2 has these patterns stored in a signature memory 4 and asserts the desired pattern configurations into the input stream decoder 10 and the PMU Array 6. The datastream enters the first version at the input stream decoder 10, and carries a clock signal that allows each character to be validly captured in a latch of the input stream decoder 10. Hereafter this data will be referred to as “clocked character data.” The input stream decoder 10 tests the incoming characters for their membership in various ranges or groupings and produces a signal for each of these ranges or groupings. For example, one grouping might be hexadecimal digits. These signals, using the same clock as the character data, may then be selectively passed along with the character data to the several pattern match units. Some exclusive range or group signals may be multiplexed together to reduce requirements for signal lines, channel or pathways. For example, small letter, capital letter, and decimal digit could all be signaled on two signal pathways where 00=none of these groups, 01=small letter, 10=capital letter, and 11=decimal digit.

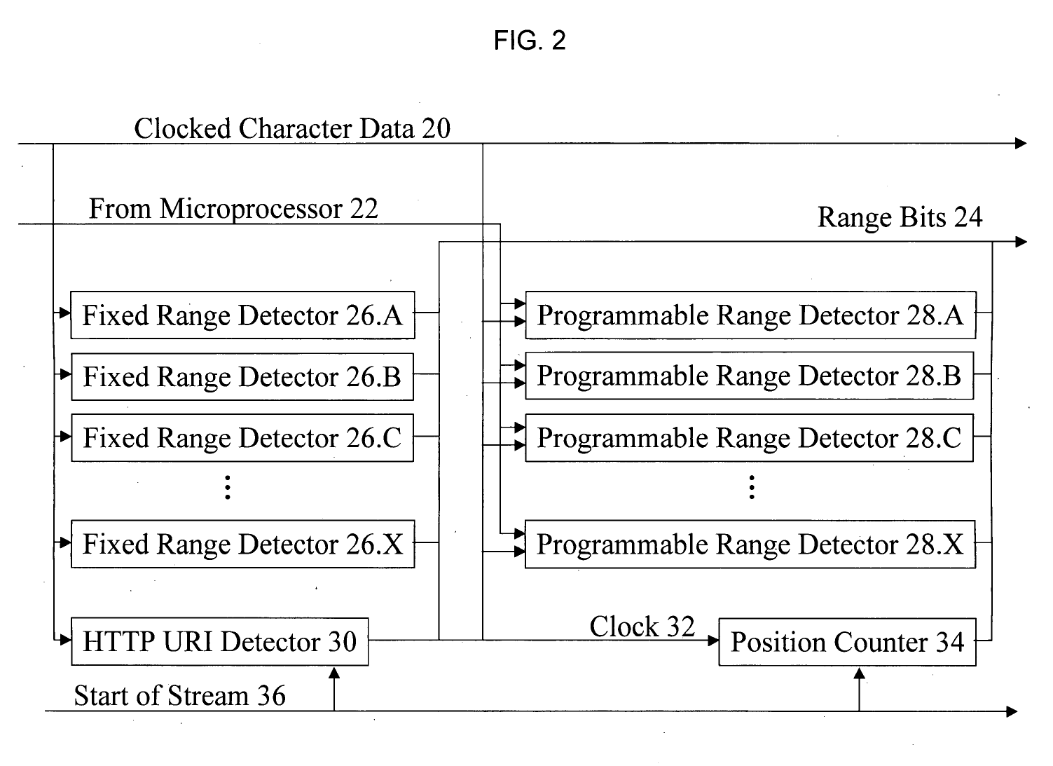

Referring now generally to the Figures and particularly to FIG. 2. FIG. 2 is a schematic of the input stream decoder 10 of FIG. 1. The input stream decoder 10 may consist of two kinds of range detector units. First is the fixed range detector group 26.A-X, which has hard wired configuration bits. Second is the programmable range detector group 28.A-X, which is configured by the microprocessor 2. Also, the range bits of the fixed range detector 26 can be multiplexed together while the programmable range detector 28 results must all be carried on separate bits. These range match bits may be thought of as a group extending the size of a single character that is carried along with the clocked character data 20. The clocked character data 20 passes through the block and also enters each range detector. The position counter 34 may count the clocks of the character clock and may then be reset by a start-of-data-stream signal 36. The start-of-stream signal 36 may come along with the clocked character data 20 from a source or circuit responsible for creating the data stream.

The Hypertext Transfer Protocol Uniform Resource Identifier detector, or “HTTP URI detector”, is a more sophisticated detector containing circuitry for matching the beginning and ends of strings Uniform Resource Identifier (“URI”) that conform to the Hypertext Transfer Protocol (“HTTP”). Additional circuitry not shown may be required for resynchronizing the range bits with the incoming clocked character data. Normally this would result in one clock cycle of latency being added to the clocked character data because normally it would take less than one clock cycle for a comparison circuit to settle.

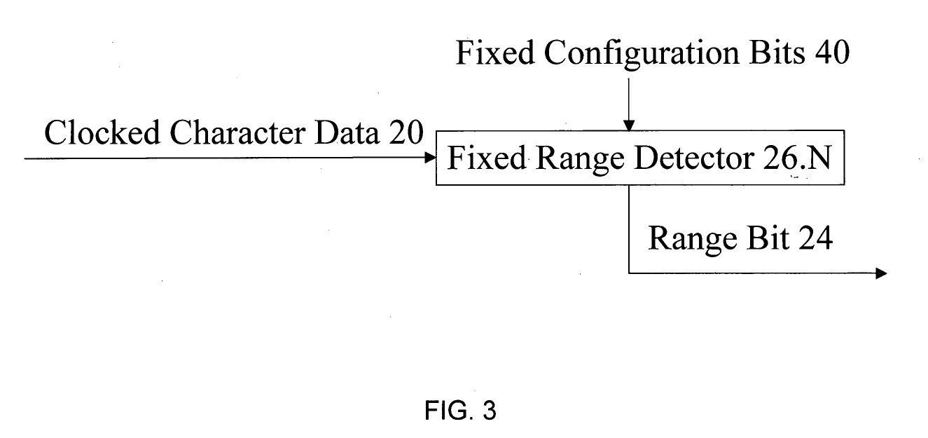

Referring now generally to the Figures and particularly to FIG. 3., FIG. 3 is an illustration showing a fixed range detector of the stream decoder of FIGS. 2 and 3. The fixed range detector 26.N logically may contain a conventional range detector circuit wherein the configuration bits are of fixed values. To save gates, these circuits may be logically reduced to produce smaller fixed range detector units that vary depending on the ranges or groups of character values that one or more fixed range detectors are checking for. For example, a matching portion of a range detector that is checking for decimal digits might be reduced 5 gates: to a two input “NOT_AND” gate (A) with bits 0 and 3 as inputs, a 2 input “NOT_AND” gate (B) with gate A and bit 3 as inputs, a two input “AND” gate (C) with bits 4 and 5 as inputs, a 2 input “NOT_OR” gate (D) with bits 6 and 7 as inputs, and a 3 input “AND” gate with gates B, C, and D as inputs.

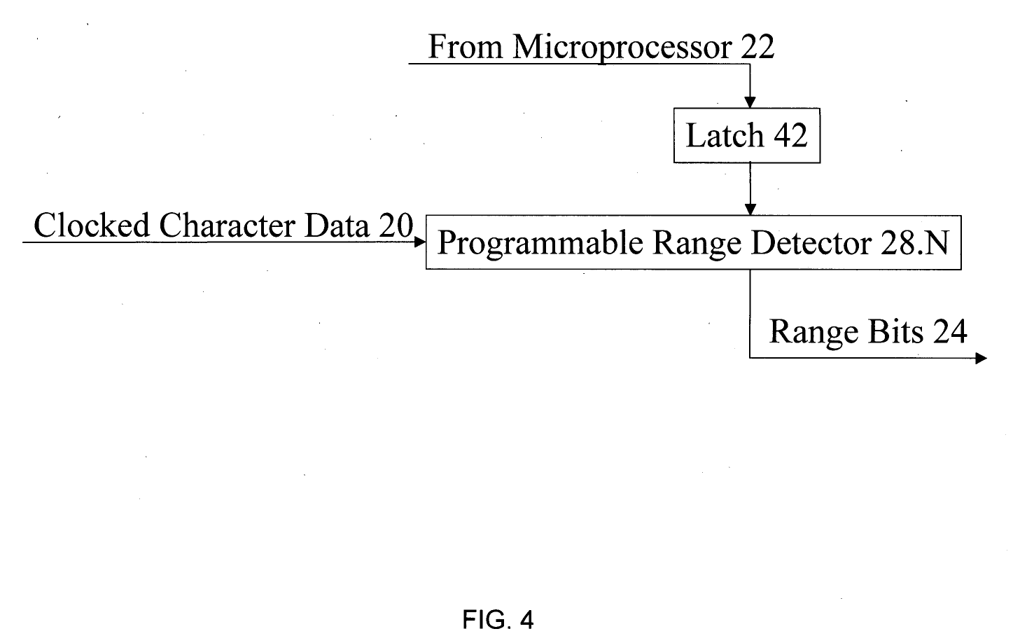

Referring now generally to the Figures and particularly to FIG. 4, FIG. 4 is an illustration of a programmable range detector 28.N of FIG. 2. In contrast with the fixed range detector 26.N of FIG. 3, the programmable range detector 28.N would preferably include a range of configurable matching circuitry, wherein certain embodiments of the programmable range detector 28.N might include subsets of configurable matching circuits to reduce size, and possibly functionality, of these alternate embodiments of the programmable range detector 28.N. The microprocessor 2 is enabled to write the configuration data for the programmable range detector 28.N into a latch 42 as clocked by the processor write clock.

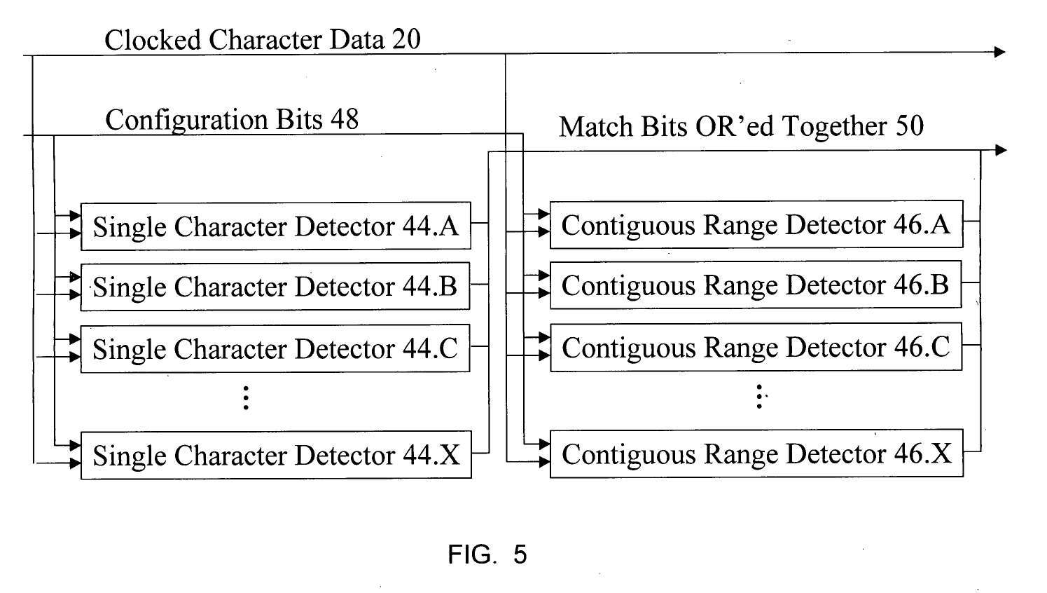

Referring now generally to the Figures and particularly to FIG. 5, FIG. 5 is an illustration of a character range detector that consists of two kinds of detection circuits. The single character detectors 44.A-X match against one character of input data 20 at a time. Contiguous range detectors 46.A-X match contiguous numeric ranges of characters. For example, a hexadecimal digit detector might use three contiguous range detectors: one for the digits “0”-“9”, one for the letters “a”-“f”, and one for the letters “A”-“F”. A white space detector would probably use a number of single character detectors: one for space, one for tab, one for carriage return, one for line feed, etc. The results of these combinations of ranges and single character detections may be input together into an OR logic circuit or process to give a single signal that indicates whether any member of the set of these characters have been matched. This signal resulting from the OR logic process is the range bit that is the output of the circuit. This OR circuit built for, or an OR process enabled to sustain, high throughput would assert its range data for a character in the clock cycle subsequent to that character data's arrival, necessitating a one clock cycle delay of the character data so that the character data input process is again synchronized with the range bits produced by the input stream decoder.

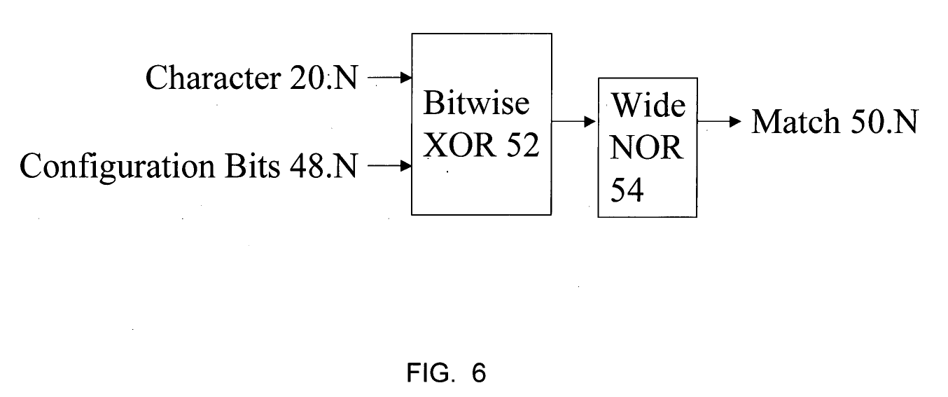

Referring now generally to the Figures and particularly to FIG. 6, FIG. 6 is an illustration of a single character detector 44.N of the first version of FIG. 1. The single character detector 44.N accepts a byte of configuration bits 48.N from the microprocessor 2. In the case of a fixed single character detector 26, the configuration bits 48.N may instead be hard wired. In certain embodiments, these configuration bits 48.N are bitwise NOT_OR'ed with the character 20.N to be matched. That is, bit zero of the configuration data 48.N is input into a NOT_OR circuit or logical process with bit zero of the character data 20.N, and so on. These 8 resulting bits are then input into an OR circuit or logical process together to produce a match bit. If any bit of the configuration data does not match the character data bit presented, the logic produces a one value which in turn causes the match signal to be a zero value. If all bits match the match signal will therefore be a one value. The circuitry above simply does the matching function. The entire practical circuit would have clocked latches and a method for synchronizing the detector data with the input character stream 20.

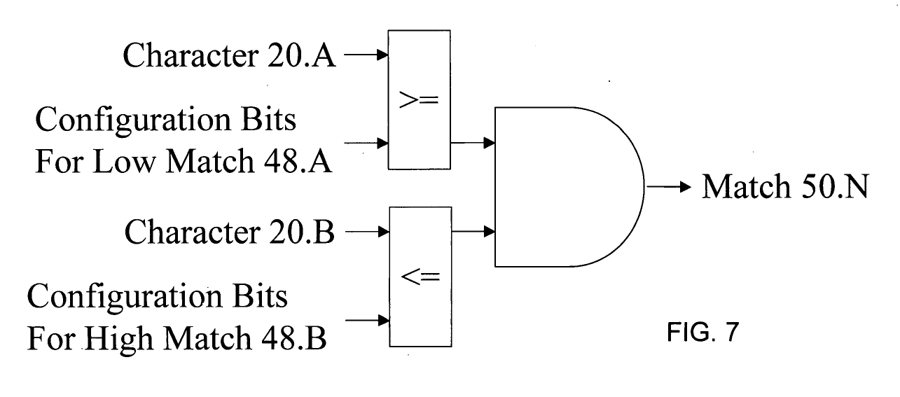

Referring now generally to the Figures and particularly to FIG. 7 is an illustration of a contiguous range detector 46.N of the first version of FIG. 1. The contiguous range detector 46.N is configured by two parameters. The first parameter is configuration bits for low match 48.A, which specifies the lowest character to match in the contiguous range. The second parameter is configuration bits for high match 48.B, which specifies the highest character to match in the contiguous range. Assuming a continuous unsigned range is desired for all eight bits of character data, a 9 bit subtract would be employed in both math functions. For the greater than or equals function the configuration data is subtracted from the character data. A positive result (bit 8==0) indicates the character is greater than or equal to the configuration byte. For the less than or equals function the character data is subtracted from the configuration byte. A positive result (bit 8==0) indicates that the character data is less than or equal to the configuration byte. These bits, inverted, are AND-ed together to produce the range match result. The circuitry above simply does the matching function. Certain alternate preferred embodiments of the contiguous range detector 46.N comprise clocked latches and are designed to synchronize detector data processing with input character stream 20.

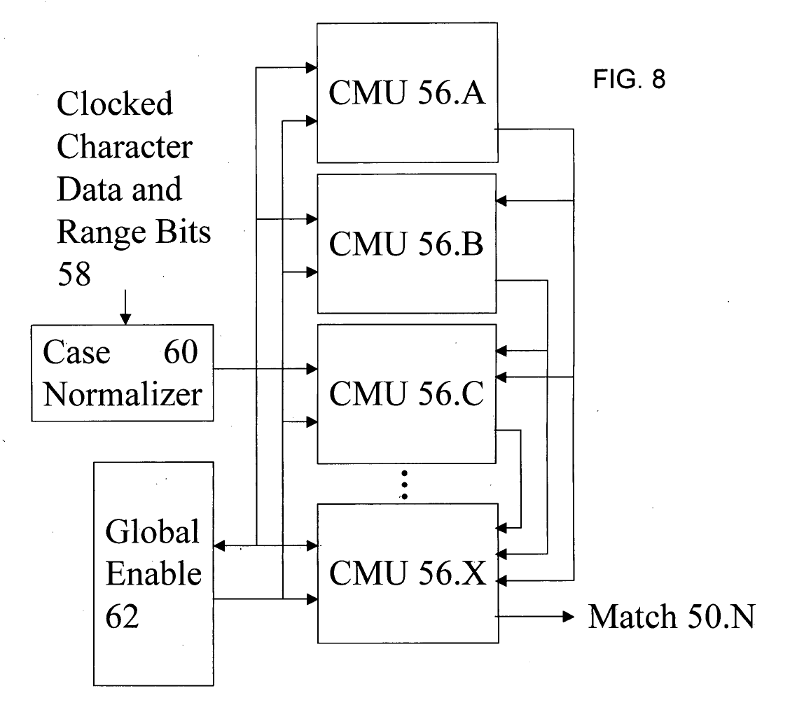

Referring now generally to the Figures and particularly to FIG. 8, FIG. 8 is a schematic diagram of a PMU 6 of the first version of FIG. 1. The PMU 6 may comprise of a number of interconnected character match units CMU 56. All character match units 56 see the same byte of character data 20 at the same time. More than one character match unit 56 is required because of the problem of matched strings starting inside other matching strings. The match status that starts on a given clock cycle is therefore maintained by a sequence of CMU's 56. For example, consider the signature “elevator” and the match set “elelevator.” On cycle one the CMU's see the first letter “e” and a match comes out of the first CMU 56.A. On cycle two the “1” matches in the second CMU 56.B and so the match continues. On the third cycle this original match still continues in CMU 56.C, but another match is also starting in CMU 56.A. It is this ability to investigate whether a new match is starting every clock cycle even if other matches are ongoing that is enabled by having multiple CMU's each matching a single character or meta-pattern. Having this arrangement also removes the requirement of having backward connected CMUs.

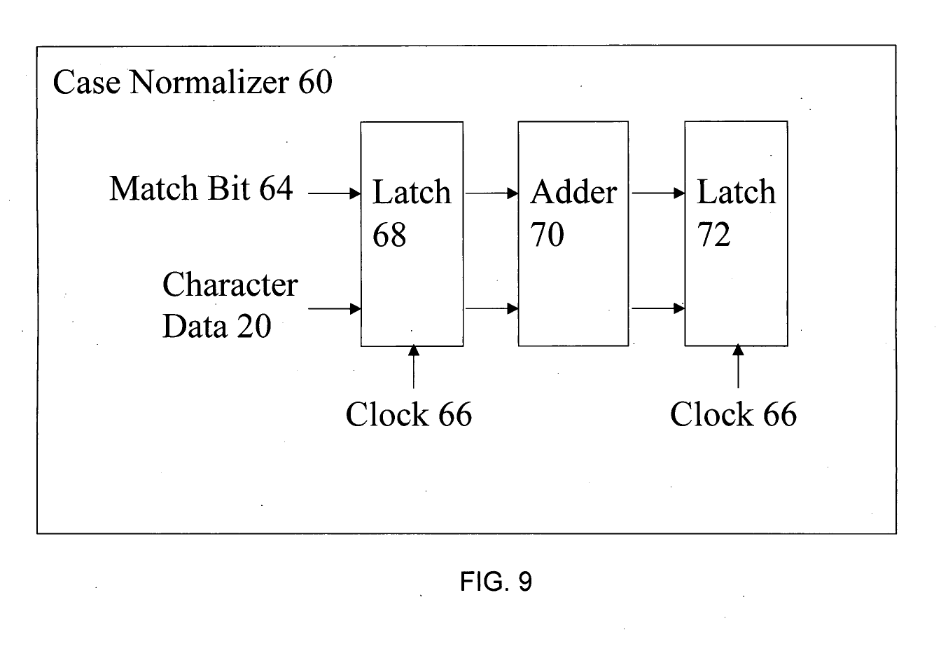

Referring now generally to the Figures and particularly to FIG. 9, FIG. 9 is an optional case normalizer circuit 60 of the input stream decoder 10 of FIG. 1. The case normalizer circuit 60 optionally normalizes the case of incoming characters to lower case if the desired match is case insensitive. The case normalizer circuit uses as input a match bit 64 that indicates whether or not the input character 20 matches the range of capital letters “A” to “Z”. If match bit 64 is set, hexadecimal 0x20 is added to the incoming character to convert it from upper to lower case. The case normalizer circuit shows the latches 68, 72 that would surround such a calculation 70 in most high performance implementations.

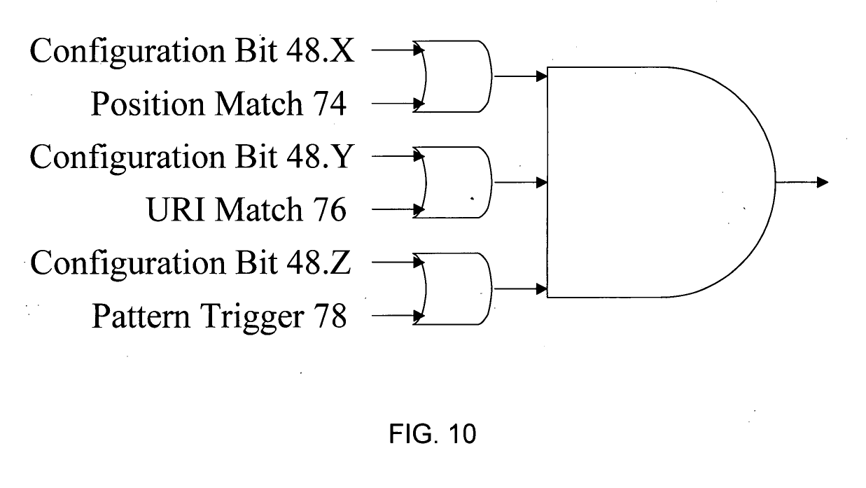

Referring now generally to the Figures and particularly to FIG. 10, FIG. 10 illustrates an optional global enable circuit of a PMU 6.N of FIGS. 1, 8 and 9. Based on configuration data 22 received from the microprocessor 2, the PMU 6.N may want to match only data in a certain position range from start of a data stream 20 or some other discernable anchor within or related to a data stream 20. It may only want to match symbols contained within an HTTP URI. One or more PMU's 6 may be designed, programmed and/or applied to look for certain patterns as a continuation of other patterns in other PMU's. In these cases, these enable bits external to the PMU are combined into a global enable for the PMU. This signal is then supplied to all the CMU's to conditionally affect their behavior.

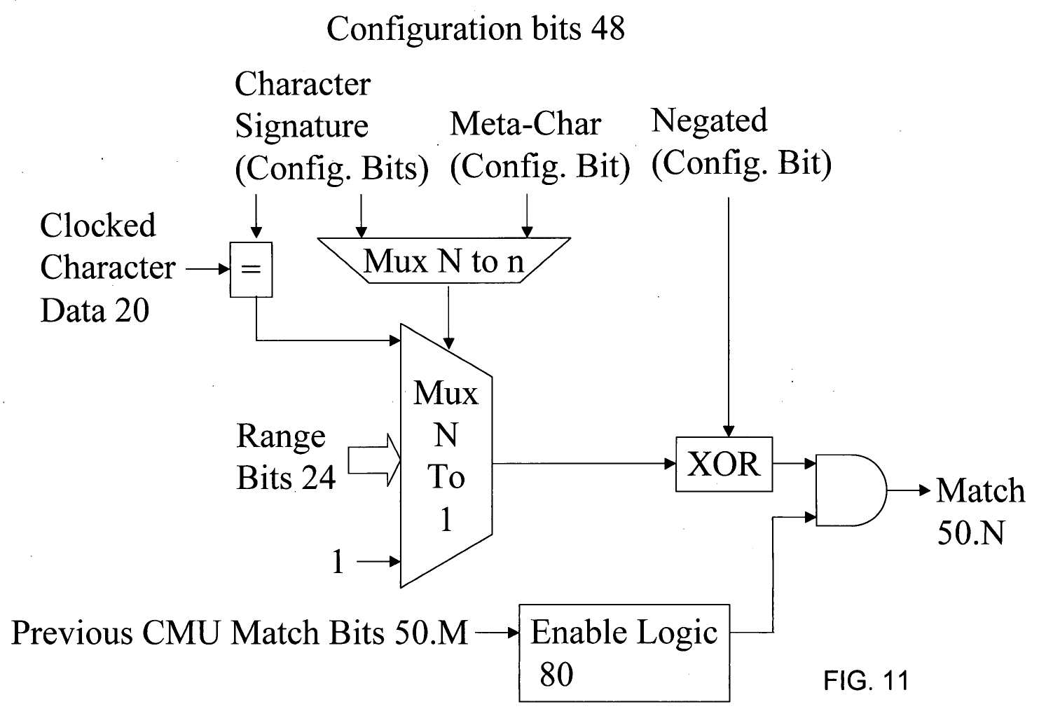

Referring now generally to the Figures and particularly to FIG. 11, FIG. 11 is a schematic of a CMU 56.N of FIGS. 1 and 8. The CMU 56.N performs at least two distinct functions. First, it matches an exact character in a fashion identical to that of a single character detector 44.N. Second, it can interpret the configuration data 48 as a “meta-char”, indicating that it should instead assert one of the range bits synthesized by the input stream decoder 10. This is accomplished with a multiplexer capable of selecting the character match bit, any of the range bits, and even “1”, indicating anything should produce a match here. This single match bit from one or the other of these sources is then, based on the “negated” configuration bit 48.N, and potentially inverted to indicate that the given character was anything other than the configured match. For example, one might want to match anything that is not a character. Finally, this basic match bit 50.M is combined with the enable bit 80 synthesized from CMU 56.N matches on the previous clock cycle and the global enable to produce the match bit for this CMU 56.N.

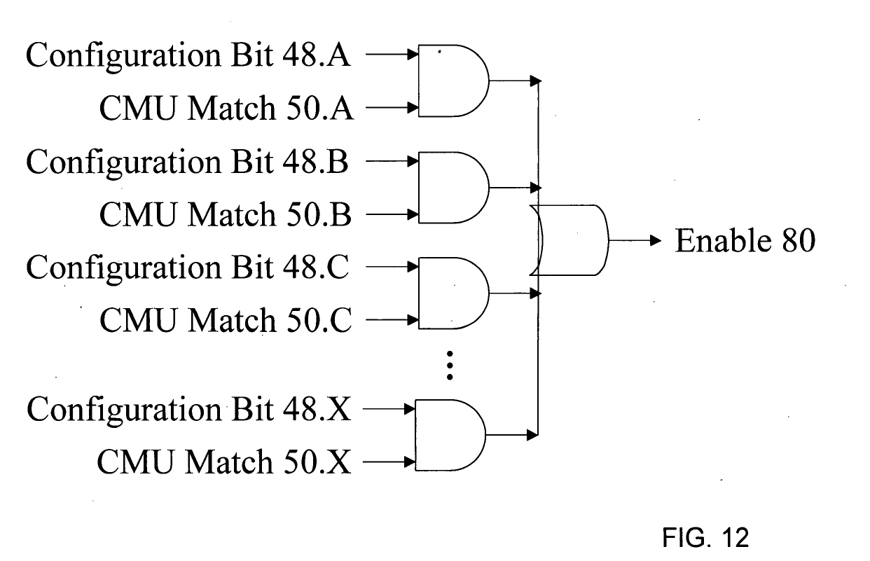

Referring now generally to the Figures and particularly to FIG. 12, FIG. 12 is an illustration of the circuitry to enable a CMU 56.N. An enable bit 80 is synthesized from match bits of lower order CMU's 56.N and the local CMU 56.N and the global enable, which can be considered a yet lower order CMU 56.N. Based on configuration bits 48 supplied by the microprocessor 2, each of these sources is asserted or ignored and then the asserted bits are combined to form the CMU 56.N enable signal 80. How these bits might be used is illustrated by the case of matching any sequence of capital letters in a single CMU 56.N. The CMU 56.N would be configured to assert the meta-character data range bit indicating the character is included in the range “A” to “Z.” Using this enable logic the CMU 56.N match result would then be fed back into itself. This would cause a match output to be generated by this one CMU 56.N for as long as a continuous steam of upper case letters entered the CMU 56.N as character data.
A CMUn is enabled if global enable is asserted and any of the following is true:
   If CMU(n−1) has generated a match on the previous data input
   If CMU(n) has generated a match on the previous data input and CMU(n) is qualified by “+” or “*” repetition.
   If CMU(n−x) has generated a match on the previous clock and all CMUs from CMU(n−x+1) to CMU(n−1) (i.e. all CMUs that fall in between n−x to n) are qualified with a “*” or “?” repetition.

The global enable signal generated as described in FIG. 11 (A combination of pattern match signals from other PMUs or anchoring to a position or URI, etc.) is also considered similar to a match of a lower order CMU (lower than CMU0).

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

We claim:

1. In a network computer comprising a plurality of character matching units (“CMU's”), the network coupled with an information technology network, a method for general expression matching, the method comprising:
a. storing a signature expressing a general expression within a memory, the memory coupled with each of the plurality of CMU's;
b. writing a first signature character of the general expression into a first CMU;
c. receiving a first character of a data stream from the information technology network;
d. writing the first character of the data stream into a first CMU;
e. enabling the first CMU to compare the first signature character against the first character of the data stream; and
f. when the first CMU detects a match between the first signature character and the first character of the data stream, enabling a second CMU to compare a second signature character of the general expression against a second character of the data stream.

2. The method of claim 1, wherein the signature expressing the general expression comprises N characters, and the N CMU's of the plurality of CMU's are organized in a serial order of N CMU's, the method further comprising:
g. writing a succeeding signature character from the memory into the most recently enabled CMU;
h. writing a succeeding character of the data stream into the most recently enabled CMU; and
i. issuing a general expression match signal when the Nth CMU detects a character match.

3. The method of claim 1, wherein the plurality of CMU's are organized into a plurality of pattern match units, and a first pattern match unit of the plurality of pattern match units enables at least two separate CMU's of separate pattern match units upon detection by the first pattern match unit of a trigger pattern comprised within the data stream.

4. The method of claim 1, further comprising enabling at least one CMU, when a character of the data stream written into the at least one CMU is comprised within a uniform resource indicator section of the data stream.

5. The method of claim 1, further comprising enabling the CMUs when a first character of the data stream is located at a predetermined position within the datastream.

6. The method of claim 1, further comprising enabling the CMUs when a first character of the data stream is located at a predetermined position within an electronic message from which the data stream is derived.

7. The method of claim 2, further comprising generating a pattern position when the general expression match signal is issued, whereby the location of a pattern within the data stream matching the general expression is identified.

8. The method of claim 2, wherein a successive character of the data stream is simultaneously written into each of N CMU's, whereby all N CMU's are configured to simultaneously match a signature character against a same and most recently received character of the data stream.

9. The method of claim 8, wherein, only one CMU is enabled to report a match detection between the most recently received character of the data stream and signature character.

10. The method of claim 9, wherein the signature character is written into each of N CMU's prior to enabling the one or more CMU's of the N CMU's.

11. The method of claim 2, further comprising generating a character match signal when a specified signature is repeated within the data stream, the character match signal enabling a succeeding CMU of the N CMU's.

12. The method of claim 2, further comprising generating a character match signal when a specified signature is not detected within the data stream, the character match signal enabling a succeeding CMU of the N CMU's.

13. The method of claim 2, further comprising generating a character match signal when a character of the data stream written into an enabled CMU matches at least one global character, wherein the character match signal enables a succeeding CMU of the N CMU's.

14. The method of claim 2, further comprising generating a character match signal when a character of the data stream written into an enabled CMU matches at least one local character class, wherein the character match signal enables a succeeding CMU of the N CMU's.

15. The method of claim 2, wherein the network computer further comprises a programmable character memory, and the method further comprises generating a character match signal when a character of the data stream written into an enabled CMU matches at least one programmed character stored within the programmable character memory, wherein the character match signal enables a succeeding CMU of the N CMU's.

16. The method of claim 2, further comprising generating a character match signal by negating a failure to match signal from an enabled CMU, wherein the character match signal enables a succeeding CMU of the N CMU's.

17. The method of claim 2, wherein a same successive character of the data stream is written into each CMU at each clock cycle.

18. A network computer coupled with an information technology network, the network computer comprising:
means to receive a data stream from the information technology network;
a signature memory comprising at least one regular expression;
a plurality of pattern matching units (“PMU's”) coupled with signature memory and the means to receive a data stream, each PMU comprising:
an input stream decoder coupled with the means to receive a data stream; and
a plurality of character matching units (“CMU's”) organized into an ordered series and coupled with the input stream decoder; and
a character sequencing logic coupled to each PMU, the character sequencing configured to selectively enable one or more CMU's after a pattern match is detected by at least one CMU of the network computer.

19. In a network computer coupled with an information technology network, the network computer comprising a plurality of character match units (“CMU's), a method for pattern matching comprising:
a. ordering the CMU's in a communicatively coupled sequence;
b. enabling a CMU(n) when a global enable is asserted and a CMU(n−1) has generated a match on the previous data input.

20. The method of claim 19, further comprising enabling a CMU(n) when a global enable is asserted and CMU(n) has generated a match on the previous data input and the signature character in CMU(n) is qualified by either a “+” repetition or a “*” repetition.

21. The method of claim 19, further comprising enabling a CMU(n) when:
a. a global enable is asserted and CMU(n) has generated a match on the previous data input;
b. a CMU(n−x) has generated a match on the previous clock signal receipt; and
c. all CMUs from CMU(n−x+1) to CMU(n−1) have characters that are qualified by either a “?” repetition or a “*” repetition.
